(19) United States
(12) Patent Application Publication
(10) Pub. No.: US 2006/0055296 A1
(43) Pub. Date: Mar. 16, 2006

(54) Flat fluorescent lamp having ultra slim thickness

(76) Inventors: Deuk-Il Park, Suwon (KR); Choong-Yop Rhew, Suwon (KR); Young Jin Hyun, Hwaseong (KR)

Correspondence Address: PARK LAW FIRM, 3255 WILSHIRE BLVD, SUITE 1110, LOS ANGELES, CA, 90010, US

(21) Appl. No.: 11/135,746

(22) Filed: May 24, 2005

(30) Foreign Application Priority Data
Sep. 11, 2004 (KR) 10-2004-0072846

(51) Int. Cl. H01K 1/30

(52) U.S. Cl. 313/116

(57) ABSTRACT

The present invention discloses a flat fluorescent lamp having a plurality of meandering discharge channels, especially, a flat fluorescent lamp having an ultra slim thickness by minimizing dark regions generated by cross walls forming a meandering shape. The flat fluorescent lamp includes first and second substrates having external electrodes. The flat fluorescent lamp includes a sidewall formed on any one of the two substrates, curved to correspond to the edges of the two substrates, and bonded to the two substrates, for forming an airtight space for discharge, and cross walls formed on one or more surfaces of the two substrates for forming a plurality of independent meandering discharge channels, the cross walls being comprised of first cross walls curved in a vertical axis for forming the meandering discharge channels, and second cross walls incorporated with the first cross walls or the side wall in a horizontal axis.

### TECHNICAL FIELD

The present invention relates to a flat fluorescent lamp used as backlight or illumination of a liquid crystal display, and more particularly to, a flat fluorescent lamp having an ultra slim thickness by minimizing dark regions generated by cross walls forming a meandering shape.

### BACKGROUND ART

Among the flat displays, a liquid crystal display (LCD) that is a passive display employs a cold cathode fluorescent lamp (CCFL), an external electrode fluorescent lamp (EEFL), an external internal electrode fluorescent lamp (EIFL), a flat fluorescent lamp (FFL), an electro luminescence (EL) and a light emitting diode (LED) as a light source, namely, a backlight unit. The-CCFL that has been reliably commonly used for an extended period of time is mostly applied to a thin film transistor liquid crystal display (TFT LCD).

The backlight method using the CCFL has a direct type or an edge type. The direct type CCFL uses a few tens of lamps, which reduces lamp reliability of the LCD. Also, the direct type CCFL is economically disadvantageous due to the high assembly unit cost. The edge type CCFL irradiating light from the ends cannot obtain sufficient luminance for a large-sized LCD panel.

Recently, the FFL has been actively examined as the backlight unit. The FFL has high luminance and lamp reliability, improves optical efficiency and cuts down the unit cost of production of the LCD.

Generally, the FFL is divided into a CCFL type and an EEFL type by the electrode arrangement.

In the CCFL type FFL, all discharge channels are divided by cross walls and extended as one meandering channel. The starting end of the discharge channel faces the terminating end thereof, and a fluorescent film is coated on the long discharge channel.

The CCFL type FFL includes the long discharge channel, and thus requires a high discharge initiation voltage proportional to the length of the discharge channel. That is, the CCFL type FFL needs a few tens kV of high voltage for lighting. Accordingly, an output voltage of an inverter rises, and power loss occurs by electronic wave failure and voltage leakage. When the CCFL type FFL is used as the backlight unit, the LCD is not suitable for home use.

On the other hand, the EEFL type FFL performs a discharge operation within a relatively shorter distance than the CCFL type FFL by arranging electrodes outside both ends of a glass substrate including discharge channels. The EEFL type FFL can stably perform the discharge operation even in a low voltage. In addition, the electrodes can be easily installed on the EEFL type FFL.

However, in order to obtain target luminance, the EEFL type FFL using the external electrodes must have a large electrode area to sufficiently flow a current. An increased dead, space of the lamp deteriorates the outer appearance of the lamp.

A plurality of discharge channels are formed on the EEFL type FFL in the width direction. Therefore, power consumption increases to obtain an appropriate current density in each discharge channel.

When the sectional area of the discharge channels is reduced to obtain the appropriate current density in the EEFL type FFL, the number of the discharge channels and the width of the cross walls increase. When the number of the discharge channels increases, power consumption is raised, and when the width of the cross walls increases, the dark regions by the cross walls are enlarged. A diffusion plate (not shown) must be separately installed on the top end of the lamp to remove the dark regions, which thickens the backlight unit.

The present inventors made every effort to overcome low efficiency of the surface discharge type FFL, and applied FFL-related technologies for registration, such as ‘Lamp assembly using flat lamp (Korea Laid-Open Patent Application No. 2002-0072260, Sep. 14, 2002)’, ‘Flat lamp and lamp assembly using the same (Korea Laid-Open Patent Application No. 2004-0014037, Feb. 14, 2004)’, ‘Backlight unit using flat lamp (Korea Laid-Open Patent Application No. 2004-0013020, Feb. 11, 2004)’, and ‘Flat lamp and backlight unit using the same (Korea Laid-Open Patent Application No. 2004-0004240, Jan. 13, 2004)’. The present inventors suggested a method for attaining uniform luminance of the FFL by maximizing optical efficiency and minimizing non-luminescent regions by improving the structure and arrangement of the electrodes.

In addition, the present inventors have applied ‘FFL improving discharge efficiency’ for registration (Korea Laid-Open Patent Application No. 2004-58291). The FFL improved from the EEFL employs a plurality of independent meandering discharge channels. The FFL improves discharge efficiency and luminance by increasing a current density per discharge channel, lowers a discharge initiation voltage by improving an electrode structure, and reduces non-luminescent regions by external electrodes by forming electrode spaces having a larger width than the discharge channels.

The structure of the FFL improving discharge efficiency will now be explained with reference to the accompanying drawings.

FIG. 1 is a perspective view illustrating a conventional FFL having meandering discharge channels, and FIG. 2 is a perspective view illustrating a rear substrate of FIG. 1.

Reference numerals 10 and 12 denote front and rear substrates. The FFL having the meandering discharge channels have the front substrate 10 and the rear substrate 12.

The front substrate 10 includes two external electrodes 42 and 44 connected to a power supply unit 40, and the rear substrate 12 includes two external electrodes 46 and 48 connected to the power supply unit 40, a sidewall 14, cross walls 16, discharge channels 20, an exhaust channel 22, connecting units 24 and a frit glass 340.

Referring to FIG. 1, the front substrate 10 and the rear substrate 12 are boned to each other by the sidewall 14 formed at the edges of the rear substrate 20. The sidewall 14 externally isolates discharge spaces formed between the two substrates 10 and 12. As shown in FIG. 1, the sidewall 14 can be incorporated with the rear substrate 12. In addition, the sidewall 14 can be bonded to the front substrate 10 by the sealing member 340, for example, a low melting point glass such as the frit glass, or individually or collectively formed with the plurality of meandering cross walls 16. In FIGS. 1 and 2, the sidewall 14 is incorporated with the cross walls 16.

In FIG. 1, the cross walls 16 are formed on the rear substrate 12. However, the cross walls 16 can be alternately symmetrically formed on the rear substrate 12 and the front substrate 10.

A reflective layer (not shown) can be coated on the lower portion of the rear substrate 12. The reflective layer is made of white ceramic materials containing Al₂O₃, TiO₂ and WO₃ as major elements. The reflective layer improves luminance by increasing reflectivity of light generated by a fluorescent material (not shown) coated in the discharge channels 20.

The discharge channels 20 and the exhaust channel 22 are formed by closely adhering the front substrate 10 to the top surfaces of the sidewall 14 and the cross walls 16.

For conveniences' sake, the meandering cross walls 16 having a long axis are defined as first cross walls, and the meandering cross walls 16 having a short axis are defined as second cross walls.

The discharge channels are formed in a meandering shape by the cross walls 16 including the first cross walls and the second cross walls and the sidewall 14. One-side ends of the meandering discharge channels 20 are connected to the exhaust channel 22 formed in the length direction on the sidewall 14 through the connecting units 24. Here, the ends of the discharge channels 20 are formed in the opposite directions. The exhaust channel 22 formed in the length direction on the ends of the discharge channels 20 is used as an electrode space.

In detail, the front substrate external electrodes 42 and 44 and the rear substrate external electrodes 46 and 48 that are transparent or metal electrodes are extended in the length direction of the exhaust channel 22 outside the front substrate 10 and the rear substrate 12. On the front substrate 10 and the rear substrate 12, the front substrate external electrode 42 and the rear substrate external electrode 46 are commonly connected to the ground of the power supply unit 40, and the front substrate external electrode 44 and the rear substrate external electrode 48 are commonly provided with alternating current power from the power supply unit 40.

Still referring to FIGS. 1 and 2, the exhaust channel 22 is formed along the external electrodes 46 and 48 or one of the external electrodes 46 and 48. However, the exhaust channel 22 can be embodied in various forms.

The FFL can be formed by arranging the meandering discharge channels 20 in series as shown in FIG. 1, or by arranging the meandering discharge channels 20 in parallel as shown in FIG. 2.

FIG. 3 is a plane view illustrating the cross walls disposed on the rear substrate of FIG. 2 for forming the meandering shape.

As depicted in FIG. 3, reference numeral 11 denotes the plasma formed on the discharge channels, 13 denotes dark regions, 16-1 denotes the first cross walls, and 16-2 denotes the second cross walls.

The sidewall 14 and the second cross walls 16-2 vertically connected to the sidewall 14 at predetermined intervals, and the first cross walls 16-1 and the second cross walls 16-2 vertically connected to the first cross walls 16-1 are alternately disposed to form the meandering shape.

Still referring to FIG. 3, since the plasma 11 is not sufficiently formed at the connection edges of the sidewall 14 and the second cross walls 16-2 and the connection edges of the first cross walls 16-1 and the second cross walls 16-2, the dark regions 13 having relatively low luminance are formed. In detail, the discharge plasma 11 is thinned at the curved parts, and thus the dark regions 13 are formed at the curved parts. Here, a diffusion plate (not shown) disposed on the front substrate 10 for diffusing light generated in the FFL must be separated farther from the front substrate 10 in order to make the dark regions 13 invisible.

As described above, the FFL having the meandering discharge channels 20 must increase the distance between the diffusion plate and the front substrate 10 due to the dark regions 13. As a result, the thickness of the FFL increases.

### DISCLOSURE OF THE INVENTION

The present invention is achieved to solve the above problems. An object of the present invention is to provide an FFL having an ultra slim thickness which removes dark regions generated by cross walls forming a meandering shape.

Another object of the present invention is to provide an FFL having an ultra slim thickness which forms a diffusion surface on a front substrate to remove dark regions generated by cross walls forming a meandering shape.

In order to achieve the above-described objects of the invention, there is provided an FFL having an ultra slim thickness which includes first and second substrates having external electrodes, the FFL including: a sidewall formed on any one of the two substrates, curved to correspond to the edges of the two substrates, and bonded to the two substrates, for forming an airtight space for discharge; and cross walls formed on one or more surfaces of the two substrates for forming a plurality of independent meandering discharge channels, the cross walls being comprised of first cross walls curved in a vertical axis for forming the meandering discharge channels, and second cross walls incorporated with the first cross walls or the side wall in a horizontal axis.

There is also provided an FFL having an ultra slim thickness which includes first and second substrates having external electrodes, the FFL including: a sidewall formed on any one of the two substrates, curved. to correspond to the edges of the two substrates, and bonded to the two substrates, for forming an airtight space for discharge; a diffusion surface formed on the top surface of one of the two substrates that is a light emitting surface; and cross walls formed on one or more surfaces of the two substrates for forming a plurality of independent meandering discharge channels, the cross walls being comprised of first cross walls curved in a vertical axis for forming the meandering discharge channels, and second cross walls incorporated with the first cross walls or the side wall in a horizontal axis.

### BRIEF DESCRIPTION OF THE DRAWINGS

The present invention will become better understood with reference to the accompanying drawings which are given only by way of illustration and thus are not limitative of the present invention, wherein:

FIG. 1 is a perspective view illustrating a conventional FFL having serial meandering discharge channels;

FIG. 2 is a perspective view illustrating a rear substrate of a conventional FFL having parallel meandering discharge channels;

FIG. 3 is a plane view illustrating cross walls disposed on the rear substrate of FIG. 2 for forming a meandering shape;

FIG. 4 is a side view illustrating an FFL having an ultra slim thickness in accordance with the present invention;

FIG. 5 is a plane view illustrating a rear substrate having a meandering structure in accordance with a first embodiment of the present invention;

FIG. 6 is a plane view illustrating a rear substrate having a meandering structure in accordance with a second embodiment of the present invention;

FIG. 7 is a plane view illustrating a rear substrate having a meandering structure in accordance with a third embodiment of the present invention;

FIG. 8 is a plane view illustrating a rear substrate having protruding units at ends of second cross walls forming a meandering structure in accordance with a fourth embodiment of the present invention;

FIG. 9a is a view illustrating one example of the protruding units formed at the ends of the second cross walls of FIG. 8;

FIG. 9b is a view illustrating another example of the protruding units formed at the ends of the second cross walls of FIG. 8;

FIGS. 10 to 12 are plane views illustrating auxiliary electrodes in accordance with the first embodiment of the present invention;

FIGS. 13 to 15 are plane views illustrating auxiliary electrodes in accordance with the second embodiment of the present invention;

FIGS. 16 to 18 are plane views illustrating auxiliary electrodes in accordance with the third embodiment of the present invention;

FIG. 19 is a plane view illustrating auxiliary electrodes formed on meandering discharge channels having hammer-shaped second cross walls in accordance with the fourth embodiment of the present invention; and

FIGS. 20 to 22 are plane views illustrating an exhaust channel structure of a rear substrate that can be applied to the preferred embodiments of the present invention.

### BEST MODE FOR CARRYING OUT THE INVENTION

A flat fluorescent lamp (FFL) having an ultra slim thickness in accordance with the present invention will now be described in detail with reference to the accompanying drawings. Also, well-known functions or constructions are not described in detail since they would obscure the invention in unnecessary detail.

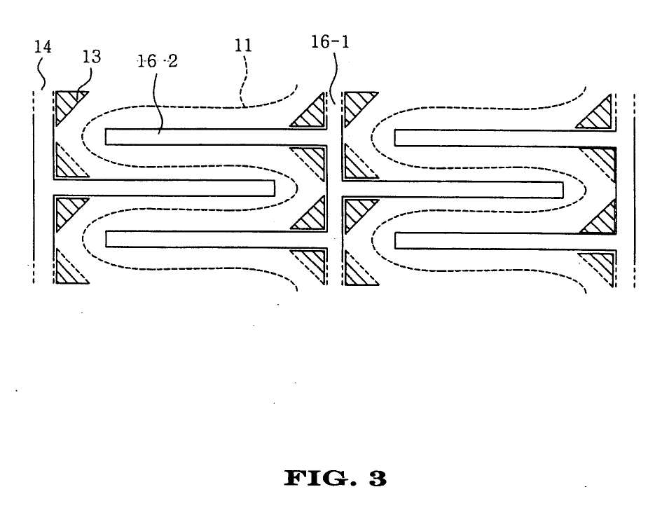

The present invention provides two methods for removing dark regions 13 of FIG. 3. The first method installs a diffusion surface for diffusing light emitted through discharge channels on a front substrate 10 of the FFL.

The second method removes the dark regions 13 by transforming first cross walls 16-1 and second cross walls 16-2.

Combinations of the two methods can be applied to the present invention.

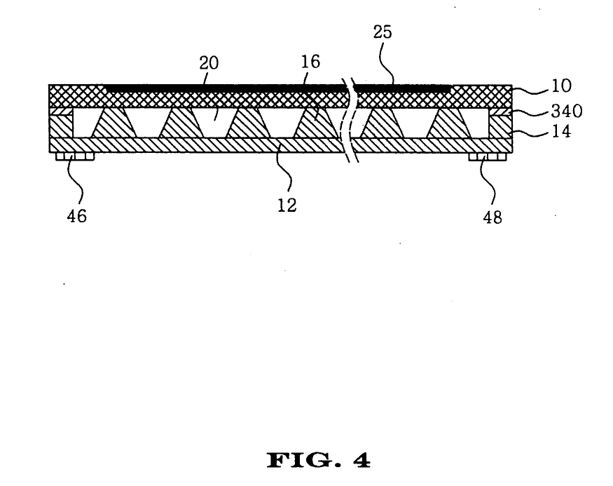

FIG. 4 is a side view illustrating the FFL having the ultra slim thickness in accordance with the present invention. The FFL having the diffusion surface for removing the dark regions 13 according to the first method will now be explained with reference to FIG. 4.

In FIG. 4, a rear substrate 12 having trapezoidal cross walls 16, a sidewall 14 and discharge electrodes 46 and 48 is bonded to a lower portion of a front substrate 10 having a diffusion surface 25 by a sealing material 340.

The front substrate 10 is made of a material having high transmissivity and high temperature resistance, such as glass. The diffusion surface 25 is installed on the front substrate 10. The diffusion surface 25 can be formed by coating a diffusion material, chemically etching glass, or finely processing the glass by a sand blasting process.

The dark regions 13 formed at the vertical connection parts of the sidewall 14 and the second cross walls 16-2 and the vertical connection parts of the first cross walls 16-1 and the second cross walls 16-2 can be reduced by installing the diffusion surface 25 on the front substrate 10. Therefore, a distance between a diffusion plate (not shown) and the front substrate 10 can be reduced by at least 20%.

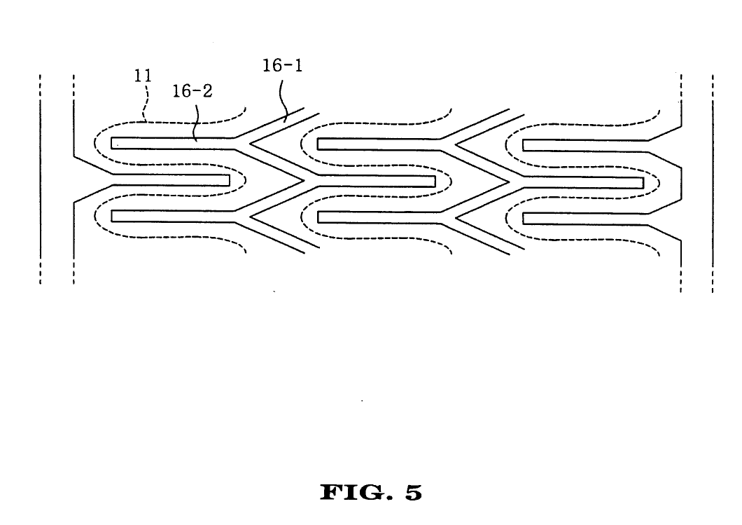

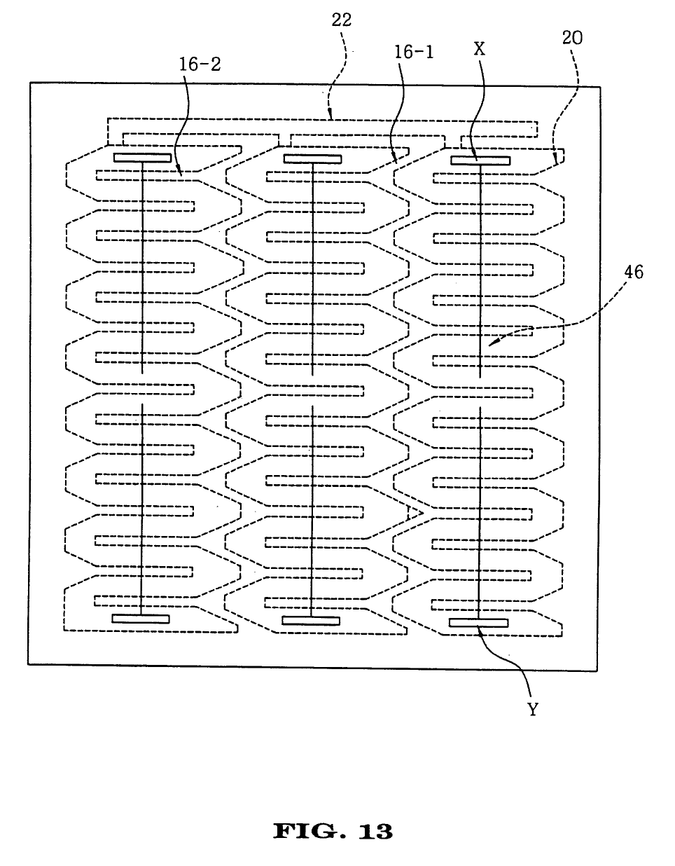

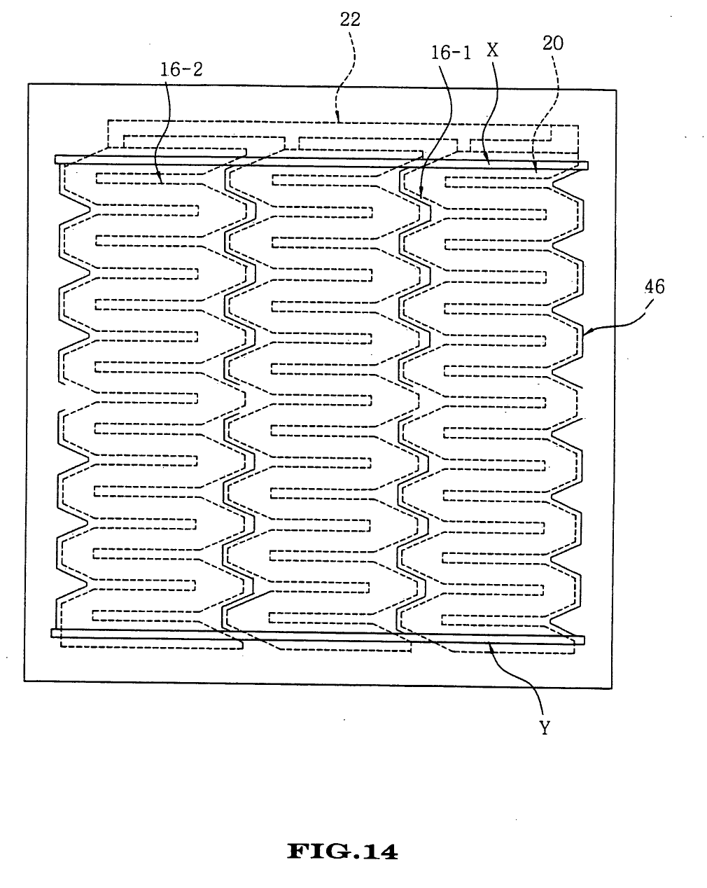

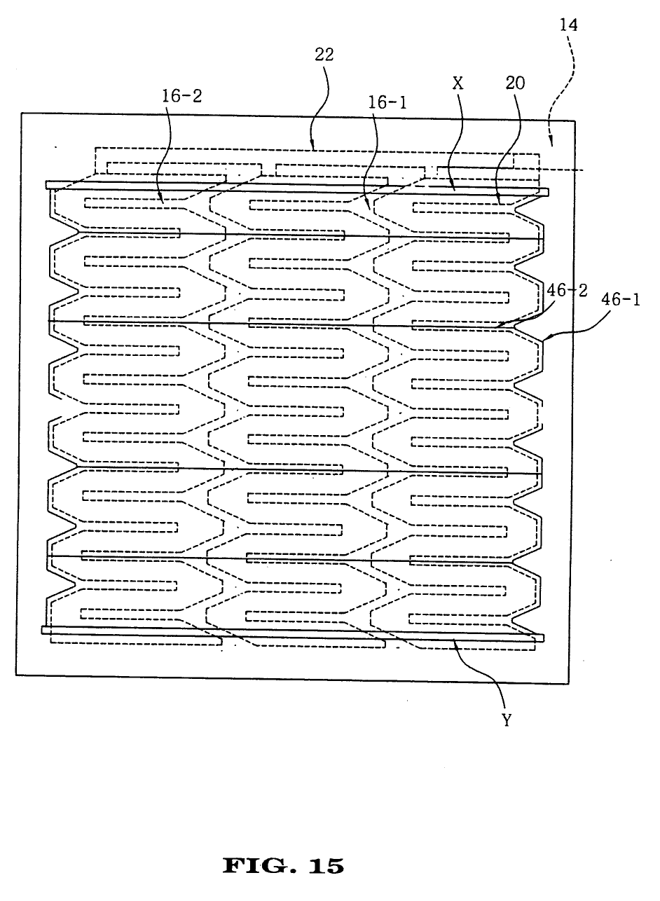

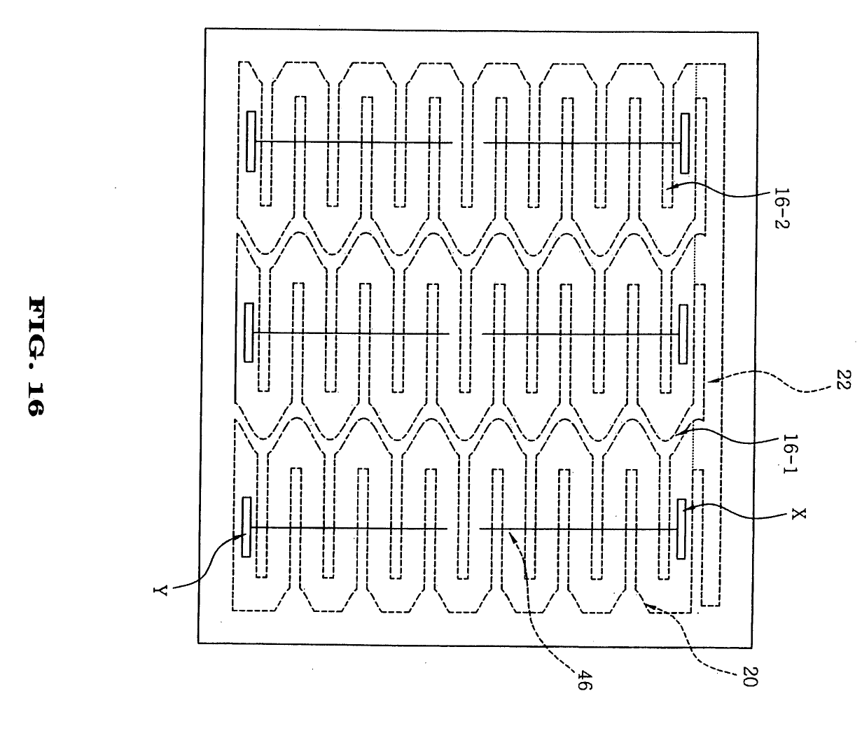

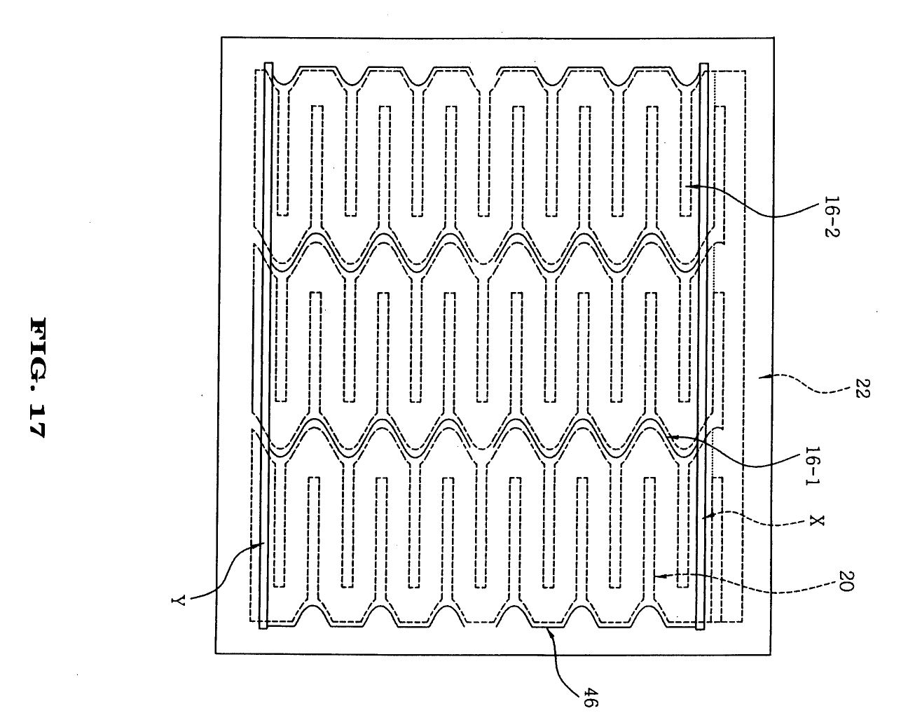

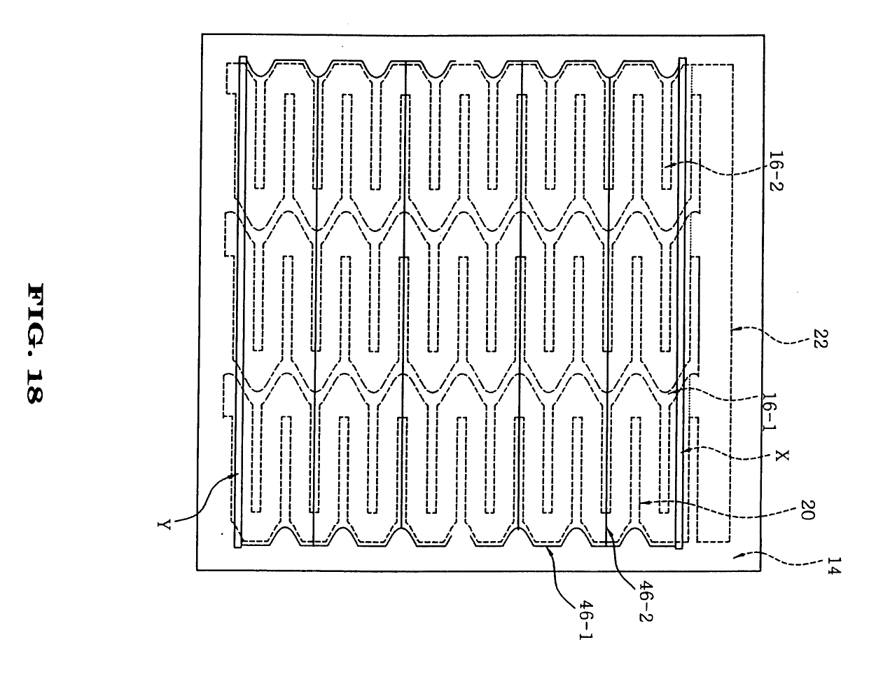

The second method will now be explained with reference to FIGS. 5 to 18.

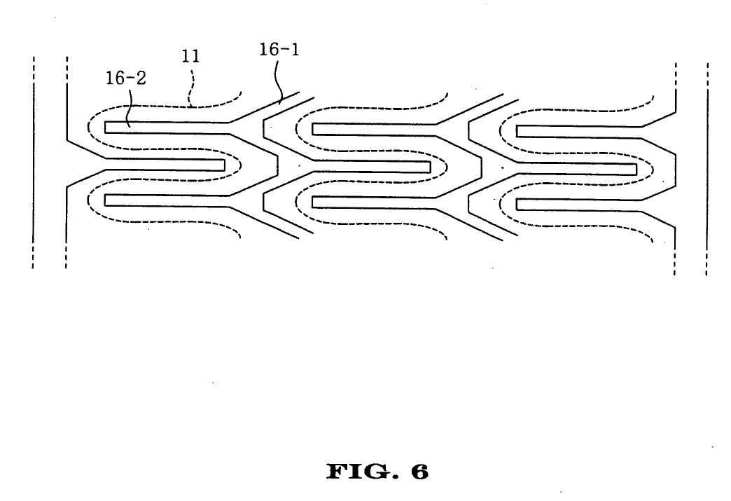

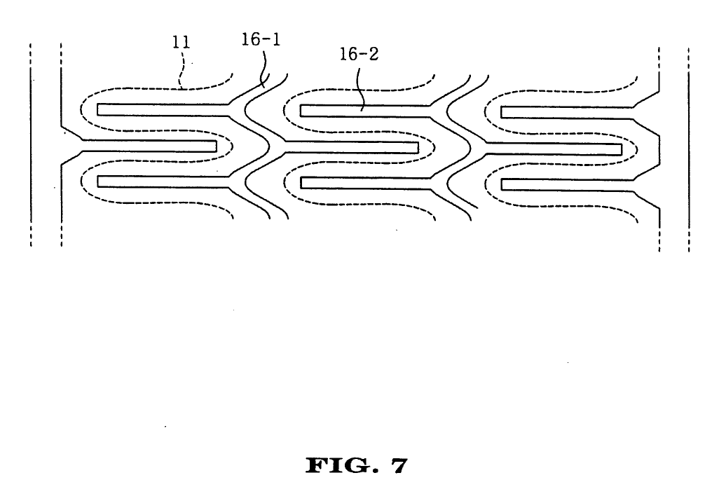

FIG. 5 is a plane view illustrating a rear substrate having a meandering structure in accordance with a first embodiment of the present invention, FIG. 6 is a plane view illustrating a rear substrate having a meandering structure in accordance with a second embodiment of the present invention, and FIG. 7 is a plane view illustrating a rear substrate having a meandering structure in accordance with a third embodiment of the present invention.

In accordance with the first embodiment of the present invention, as shown in FIG. 5, first cross walls 16-1 and a sidewall 14 are formed in a tooth shape. The vertical connection parts of the first cross walls 16-1 or the sidewall 14 and second cross walls 16-2 are removed by connecting the second cross walls 16-2 to the angular points of the tooth shapes. Accordingly, plasma 11 can be evenly formed on discharge channels 20, thereby minimizing dark regions 13 generated due to the shapes of the cross walls 16 and the characteristics of the plasma 11, namely, the discharge plasma 11 thinned at the curved parts.

In FIG. 6, first cross walls 16-1 are formed in a polygonal shape so that plasma 11 can be evenly formed on discharge channels. As a result, dark regions 13 are minimized.

In FIG. 7, first cross walls 16-1 are formed in a wave shape. Therefore, a distance between curved parts of discharge plasma 11 and the first cross walls 16-1 can be reduced to minimize dark regions 13.

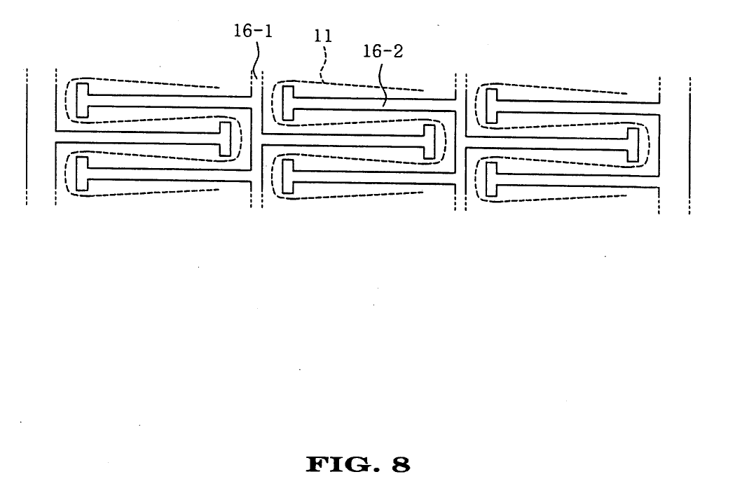

FIG. 8 is a plane view illustrating a rear substrate having protruding units at ends of second cross walls forming a meandering structure in accordance with a fourth embodiment of the present invention. Referring to FIG. 8, the rectangular protruding units 17 are formed at the ends of the second cross walls 16-2, and thus the second cross walls 16-2 are formed in a hammer shape.

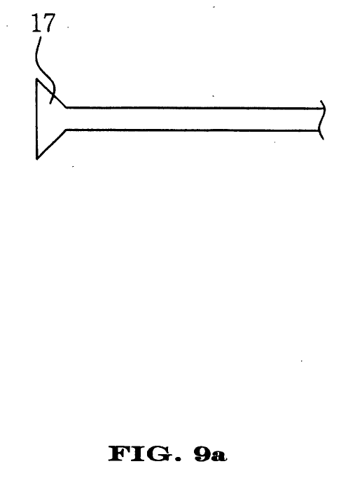

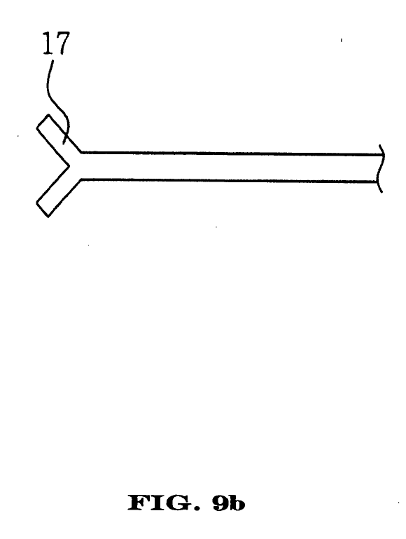

FIGS. 9a and 9b show the protruding units formed at the ends of the second cross walls of FIG. 8. In FIG. 9a, the protruding units 17 are formed in a dish shape, and in FIG. 9b, the protruding units 17 are formed in a V shape so that the second cross walls 16-2 can be formed in a Y shape.

As illustrated in FIGS. 8 and 9, the dark regions 13 can be minimized by evenly forming the discharge plasma 11 by forming the second cross walls 16-2 in the hammer, dish or Y shape.

Preferably, the discharge channels 20 formed by the cross walls 16 having the curved parts have a width of 3 to 15 mm and a height of 2 to 5 mm.

When the sections of the discharge channels 20 are too narrow, a driving voltage is raised and a discharge operation is destabilized. When the sections of the discharge channels 20 are too wide, the driving voltage is reduced, but the discharge plasma 11 is partially formed in the sections of the channels 20. As a result, fluorescent luminescence does not occur in the whole discharge channels 20, thereby partially forming the dark regions.

Preferably, a length direction channel width connecting discharge lines of the discharge channels 20 must be identical to a width direction channel width because the discharge operation is not efficiently performed in the narrow regions.

A distance between the lamp and a diffusion plate (not shown) disposed on the top surface of the lamp is reduced by about 30% by transforming the cross walls 16 as shown in FIGS. 5 to 9, and luminance efficiency is improved by about 5% by removing the dark regions 13.

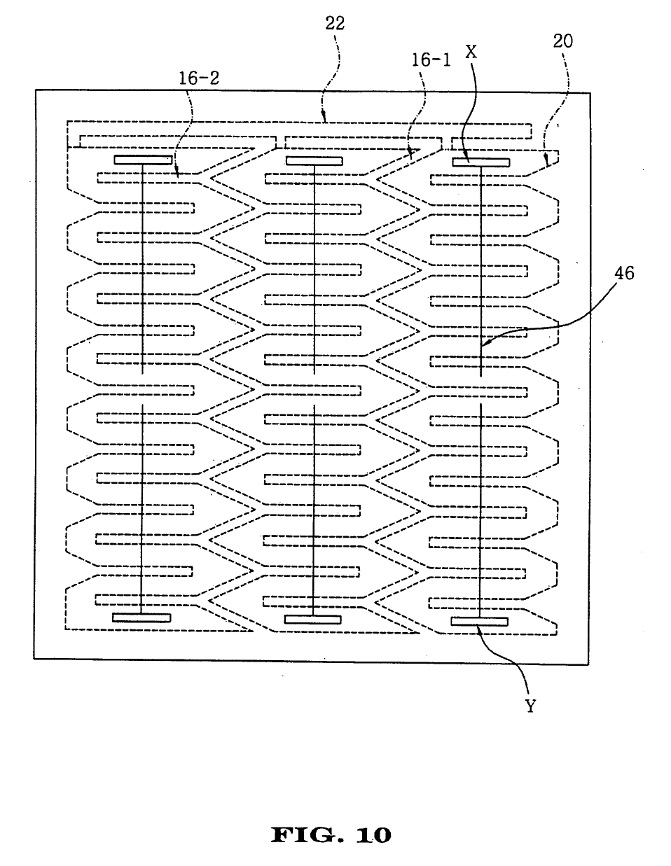

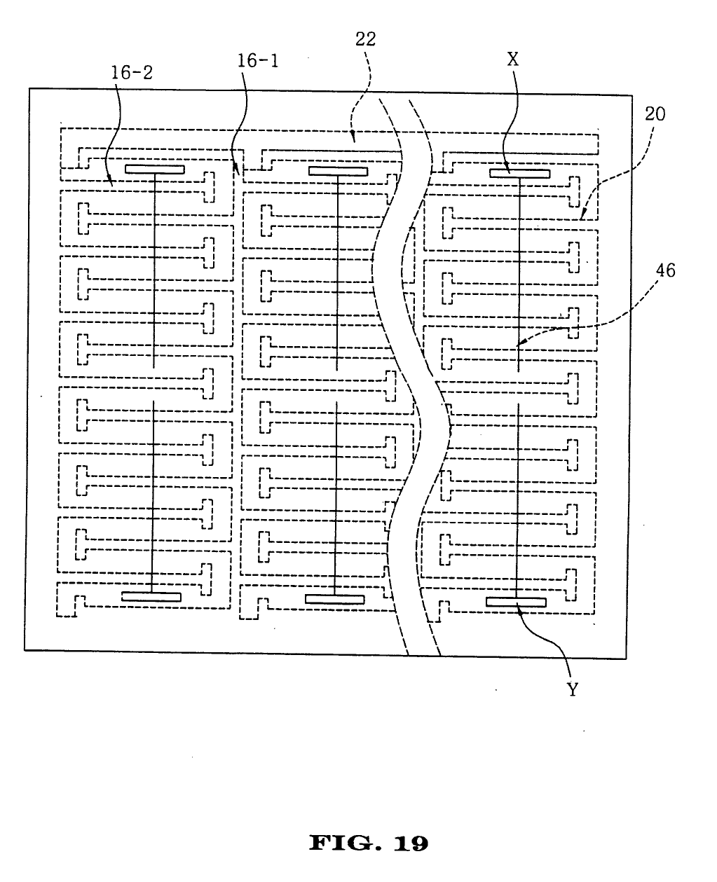

FIGS. 10 to 19 are plane views illustrating auxiliary electrodes in accordance with the first to fourth embodiment of the present invention. The auxiliary electrodes 46 are positioned on the bottom surface of the rear substrate 12 on which the plurality of independent meandering discharge channels have been formed by the cross walls 16 having the curved parts.

In FIGS. 10, 13, 16 and 19, discharge electrodes having X and Y polarities are disposed at both ends of the upper and lower portions of the independent meandering discharge channels 20, and the auxiliary electrodes 46 are extended in a solid line from each electrode to the center portion of the lamp to cross the meandering discharge channels 20. Here, X and Y electrodes are formed in each meandering discharge channel 20.

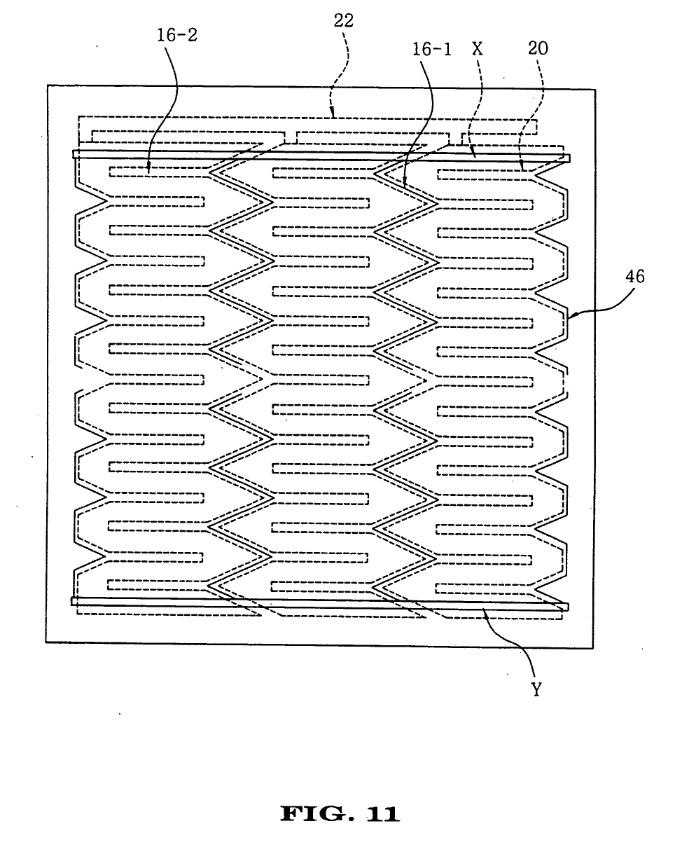

In FIGS. 11, 14 and 17, discharge electrodes having X and Y polarities are disposed at both ends of the upper and lower portions of the discharge channels 20, and the auxiliary electrodes 46 are extended in a solid line from each electrode to the center portion of the lamp, and disposed through the top ends of the length direction cross walls 16 for isolating the discharge channels 20. Here, X and Y electrodes are extended to overlap with the ends of the whole meandering shapes. In detail, the auxiliary electrodes 46 are extended to overlap with the first cross walls 16-1.

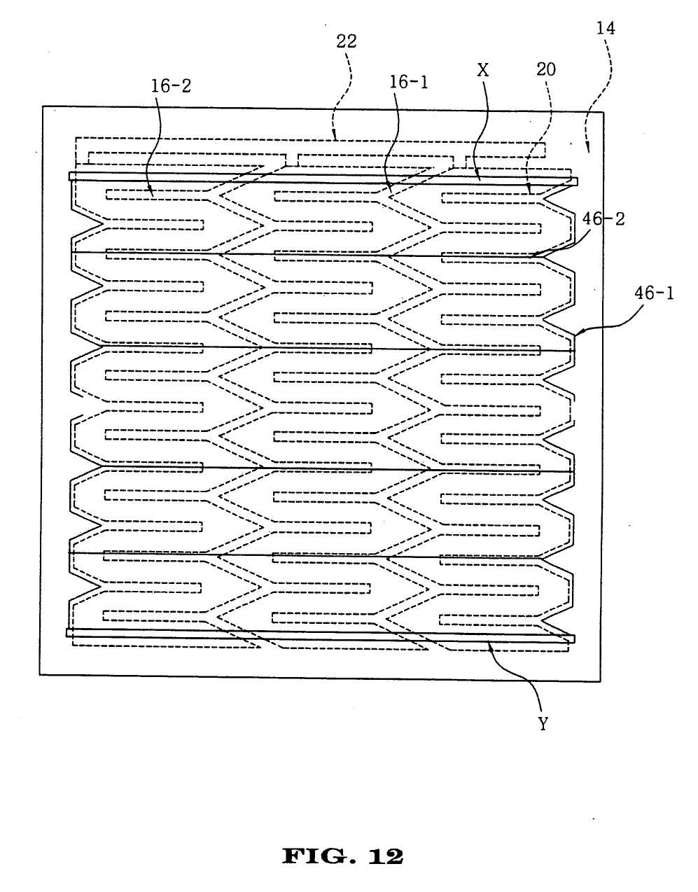

In FIGS. 12, 15 and 18, the auxiliary electrodes include discharge electrodes having X and Y polarities disposed at both ends of the upper and lower portions of the discharge channels 20, respectively, first auxiliary electrodes 46-1 formed in the length direction along both sides of the sidewall 14 vertically to each discharge electrode 20, and second auxiliary electrodes 46-2 formed in a solid line in the width direction to cross the lamp in parallel to the discharge electrodes, and connected to both ends of the first auxiliary electrodes 46-1. The second auxiliary electrodes 46-2 are disposed in the length direction at predetermined intervals to cross the lamp through the top ends of the second cross walls 16-2.

When the auxiliary electrodes 46 are embodied in various forms as shown in FIGS. 10 to 19, the preliminary discharge operation occurs between the auxiliary electrodes 46 and the electrodes, and then the main discharge operation occurs between the main discharge electrodes. The auxiliary electrodes 46 obtain voltage drop effects and improve discharge efficiency of the main discharge electrodes.

When the width of the auxiliary electrodes 46 is too large, a discharge current of the auxiliary electrodes 46 increases. Therefore, power consumption increases and luminance of the FFL decreases. Moreover, when the discharge operation is mostly performed between the main discharge electrodes, a relatively long plasma column is formed to improve discharge efficiency. If the auxiliary electrodes 46 consume much current, discharge efficiency is reduced.

Conversely, when the width of the auxiliary electrodes 46 is too small, voltage application effects decrease. Preferably, the auxiliary electrodes are formed to have an appropriate width.

Still referring to FIGS. 10 to 19, the auxiliary electrodes 46 can be extended in a continuous line from the main discharge electrodes along the discharge spaces, disposed in a discontinuous line and floated, disposed in a solid line separately from the main discharge electrodes and floated, or provided with power in a predetermined period of the discharge operation and re-floated.

Preferably, when the auxiliary electrodes 46 are installed outside the front substrate 10, optical transmissivity must be prevented from being reduced by the electrodes.

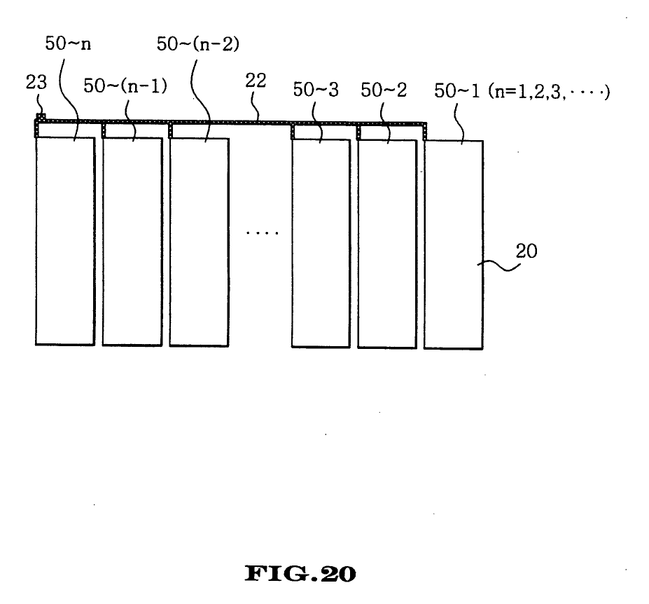

FIGS. 20 to 22 are plane views illustrating an exhaust channel structure of a rear substrate that can be applied to the preferred embodiments of the present invention.

Reference numerals 50-n (n=1,2,3 . . . ) denote independent meandering discharge channels 20 expressed as blocks. The plurality (n) of independent meandering discharge channels 20 are connected in parallel.

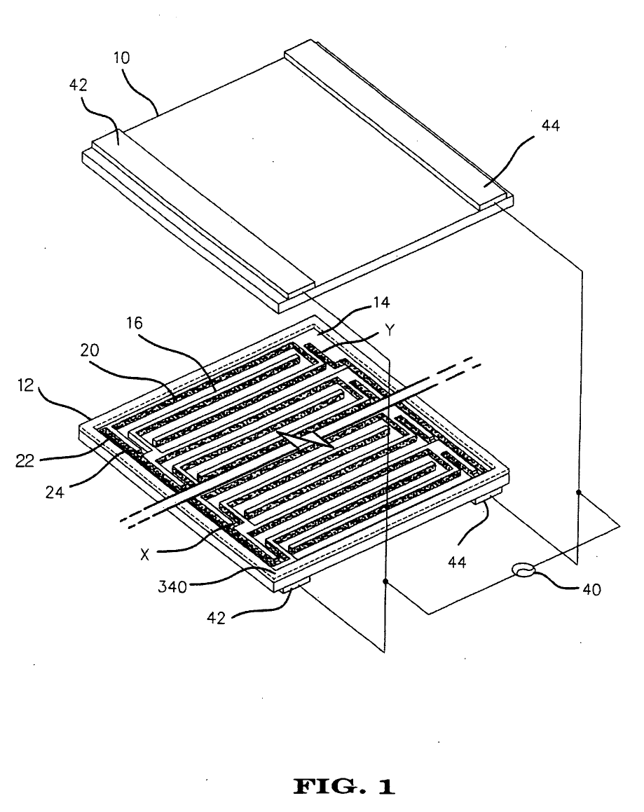

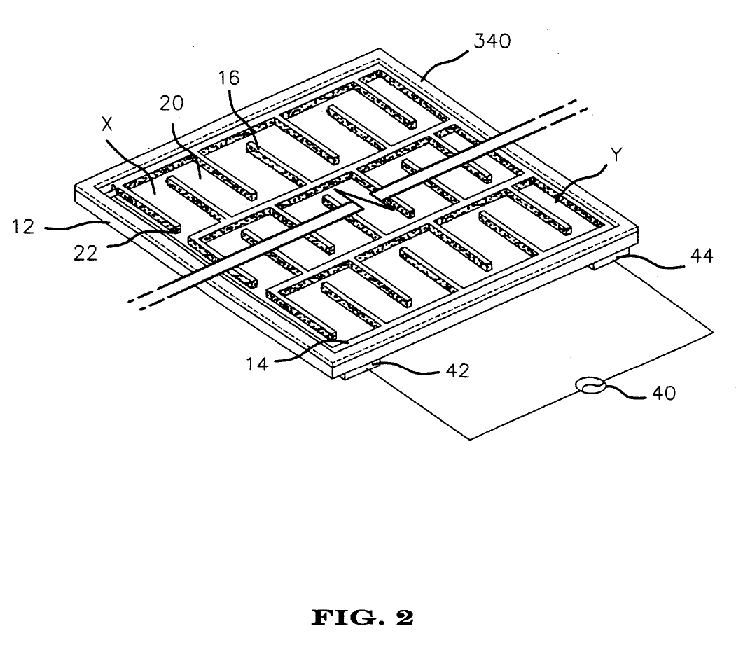

In FIG. 20, the exhaust channel 22 is formed at one-side ends of the upper or lower portions of the discharge channels 20. That is, the exhaust channel 22 is connected to the plurality (n) of discharge channels 20 through the connecting units 24 of FIG. 1. Here, an exhaust hole 23 is formed at one side end of the exhaust channel 22.

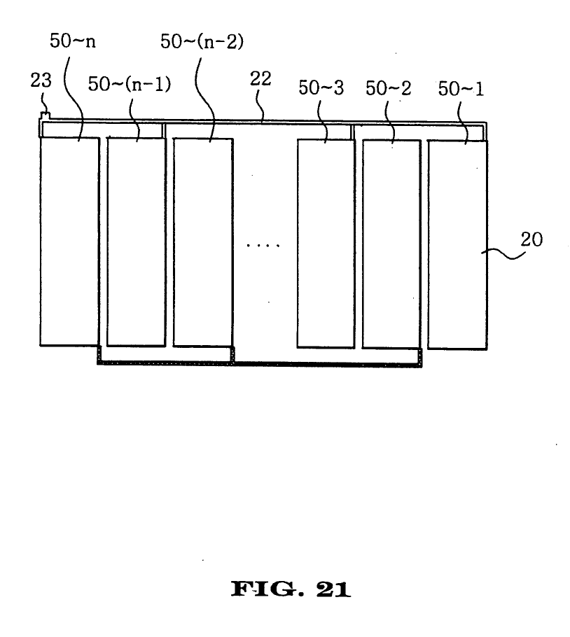

In FIG. 21, the exhaust channels 22 are formed at both ends of the upper and lower portions of the discharge channels 22. The upper exhaust channel 22 is connected to the odd-numbered independent meandering discharge channels 20, namely, 50-1, 50-3, . . . , 50-(n−1) and 50-n discharge channels 20, and the lower exhaust channel 22 is connected to the even-numbered independent meandering discharge channels 20, namely, 50-2, 50-4, . . . , 50-(n−1) and 50-n discharge channels 20. Here, an exhaust hole 23 is formed on the upper portion of the block 50-n forming the last independent meandering discharge channel 20.

Conversely, the upper exhaust channel 22 can be connected to the even-numbered discharge channels 20, and the lower exhaust channel 22 can be connected to the odd-numbered discharge channels 20.

As a result, crosstalk between the discharge channels 20 can be minimized by connecting the exhaust channels 22 as shown in FIG. 21.

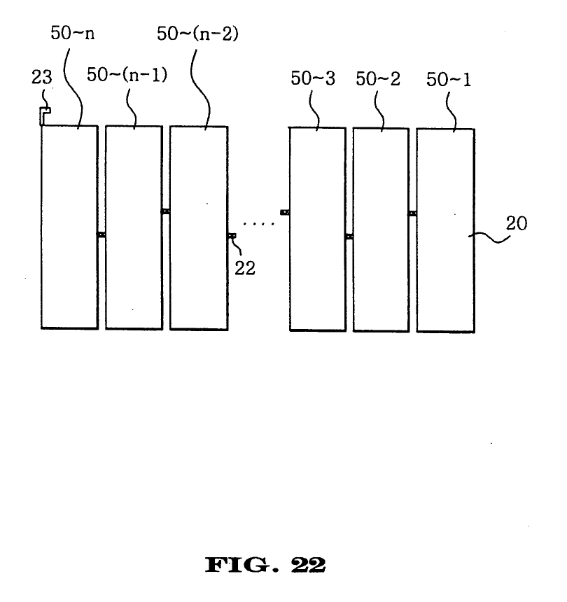

In FIG. 22, the exhaust channels 22 are formed between the independent meandering discharge channels 20. That is, the block 50-1 forming the independent discharge channel 20 is connected to the block 50-2 forming the independent discharge channel 20 through the exhaust channel 22. In addition, the block 50-2 is connected to the succeeding block 50-3 through the exhaust channel 22.

An exhaust hole 23 can be formed on the last block 50-n as shown in FIG. 20 or the block 50-1.

The discharge channels, the curved parts and the auxiliary electrodes have been explained in relation to the FFL, but other publicly-known technologies have been omitted. It is obvious that such technologies can be easily inferred by those skilled in the art to which the present invention pertains.

Although the FFL having the special shape and structure has been described with reference to the accompanying drawings, various changes, modifications and combinations can be made on the characteristics of the present invention relating to the discharge channel curved parts, the exhaust channels, the auxiliary electrodes and the methods for installing the diffusion layer on the front substrate by those skilled in the art. It must be construed that such changes, modifications and combinations belong to the protection scope of the present invention.

As discussed earlier, in accordance with the present invention, the FFL having the plurality of independent meandering discharge channels can minimize the dark regions generated by the cross walls of the discharge channels and the characteristics of the discharge plasma, thereby reducing non-luminescent regions and improving luminance.

Moreover, since the distance between the FFL and the diffusion plate can be reduced by 50% by removing the dark regions, the FFL minimizes the thickness of the lamp unit, thereby maximizing commerciality of the large-sized flat display.

What is claimed is:

1. A flat fluorescent lamp having an ultra slim thickness which includes first and second substrates having external electrodes, the flat fluorescent lamp, comprising:
a sidewall formed on any one of the two substrates, curved to correspond to the edges of the two substrates, and bonded to the two substrates, for forming an airtight space for discharge; and
cross walls formed on one or more surfaces of the two substrates for forming a plurality of independent meandering discharge channels, the cross walls being comprised of first cross walls formed in a curved shape when seen on a plane, for forming the meandering discharge channels, and second cross walls incorporated with the first cross walls or the side wall in a horizontal axis.

2. The flat fluorescent lamp of claim 1, wherein the first cross walls are formed in a wave shape.

3. The flat fluorescent lamp of claim 1, wherein the first cross walls are formed in a tooth shape.

4. The flat fluorescent lamp of claim 1, wherein the first cross walls are formed in a polygonal shape.

5. A flat fluorescent lamp having an ultra slim thickness which includes first and second substrates having external electrodes, the flat fluorescent lamp, comprising:
a sidewall formed on any one of the two substrates, curved to correspond to the edges of the two substrates, and bonded to the two substrates, for forming an airtight space for discharge; and
cross walls formed on one or more surfaces of the two substrates for forming a plurality of independent meandering discharge channels, the cross walls being comprised of first cross walls disposed in a vertical axis for forming the meandering discharge channels, and second cross walls being incorporated with the first cross walls or the side wall in a horizontal axis and having protruding units at their ends.

6. The flat fluorescent lamp of claim 5, wherein the protruding units are formed in a rectangular shape.

7. The flat fluorescent lamp of claim 5, wherein the protruding units are formed in a V shape.

8. The flat fluorescent lamp of claim 5, wherein the protruding units are formed in an inverse triangle shape.

9. A flat fluorescent lamp having an ultra slim thickness which includes first and second substrates having external electrodes, the flat fluorescent lamp, comprising:
a rear substrate disposed on any one of the two substrates, for forming discharge channels by a side wall and cross walls; and
a diffusion surface for diffusing light emitted from discharge channels.

10. The flat fluorescent lamp of claim 9, wherein the rear substrate comprises:
a sidewall formed on any one of the two substrates, curved to correspond to the edges of the two substrates, and bonded to the two substrates, for forming an airtight space for discharge; and
cross walls formed on one or more surfaces of the two substrates for forming a plurality of independent meandering discharge channels, the cross walls being comprised of first cross walls curved in a vertical axis for forming the meandering discharge channels, and second cross walls incorporated with the first cross walls or the side wall in a horizontal axis.

11. The flat fluorescent lamp of claim 10, wherein the first cross walls are formed in a wave shape.

12. The flat fluorescent lamp of claim 10, wherein the first cross walls are formed in a tooth shape.

13. The flat fluorescent lamp of claim 10, wherein the first cross walls are formed in a polygonal shape.
